(19) United States
(12) Patent Application Publication
(10) Pub. No.: US 2024/0140207 A1
(43) Pub. Date: May 2, 2024

(54) ALL-ELECTRIC ROTARY-TYPE TURF VEHICLE

(71) Applicant: TEXTRON INC., PROVIDENCE, RI (US)

(72) Inventor: Robert Johns, IPSWICH (GB)

(21) Appl. No.: 18/498,568

(22) Filed: Oct. 31, 2023

Related U.S. Application Data
(60) Provisional application No. 63/421,608, filed on Nov. 2, 2022.

(51) Int. Cl. B60L 50/60; A01D 34/00; A01D 34/66; A01D 34/74; A01D 34/78

(52) U.S. Cl. CPC B60L 50/60; A01D 34/006; A01D 34/66; A01D 34/74; A01D 34/78; B60L 2200/40; B60L 2210/10; B62D 25/10

(57) ABSTRACT

An all-electric turf vehicle, wherein the vehicle comprises a chassis, a plurality of ground engaging wheels operatively connected to the chassis, an operator station. a turf cutting unit operatively connected to the chassis, wherein the turf cutting unit comprises a plurality of rotary cutting blades driven by a plurality of electric rotary cutting blade motors, a battery bank structured and operable to provide electrical power to the plurality of electric rotary cutting blade motors, and a battery bank cradle that is removably connected to the chassis. The battery bank cradle houses the battery bank and is structured to be installed and connected to the chassis from a first side of the chassis and removed and disconnected from the chassis from a second side of the chassis.

### CROSS-REFERENCE TO RELATED APPLICATIONS

This application claims the benefit of U.S. Provisional Application No. 63/421,608, filed on Nov. 2, 2022. The disclosure of the above application is incorporated herein by reference in its entirety.

### FIELD

The present teachings relate to turf maintenance vehicles, and more particularly to an all-electric out-front rotary mower.

### BACKGROUND

The statements in this section merely provide background information related to the present disclosure and may not constitute prior art.

Currently most known turf mowers, commonly used for cutting, grooming and maintaining grass at golf courses, sporting venues, parks, consumer lawns, etc., utilize internal combustion engines to provide motive force to propel the mowers. Such known turf mowers also typically include hydraulic systems and motors to perform various operations of the respective mowers, such as raising, lowering and driving one or more grass cutting reel assembly of the mower. Implementation of such internal combustion engines systems require that the mowers further include various controllers, fuel storage tanks, and various other related components that increase the number of components required, the complexity of operation, and the frequency and complexity of service and repairs for such known turf mowers.

### SUMMARY

The invention is exemplarily described in the text below and exemplarily illustrated in the attached figures.

In various embodiments, the present disclosure provides an all-electric turf vehicle, wherein the vehicle comprises a chassis, a plurality of ground engaging wheels operatively connected to the chassis, an operator station, and a turf cutting unit operatively connected to the chassis. The turf cutting unit comprises a plurality of rotary cutting blades driven by a plurality of electric rotary cutting blade motors. The vehicle further comprises a battery bank structured and operable to provide electrical power to the plurality of electric rotary cutting blade motors, and a battery bank cradle that is removably connected to the chassis. The battery bank cradle houses the battery bank and is structured to be installed and connected to the chassis from a first side of the chassis and removed and disconnected from the chassis from a second side of the chassis.

In various other embodiments, the present disclosure provides an all-electric turf mower, wherein the mower comprises a chassis, a plurality of ground engaging wheels operatively connected to the chassis, an operator station, and a turf cutting unit operatively connected to the chassis. The turf cutting unit comprises a plurality of rotary cutting blades driven by a plurality of electric rotary cutting blade motors. The mower additionally comprises a battery bank structured and operable to provide electrical power to the plurality of electric rotary cutting blade motors, and a battery bank cradle having the battery bank disposed therein. The battery bank cradle is removably connected to the chassis utilizing a chassis mounting bracket that is structured and operable to install and connect the battery bank cradle to the chassis from a first side of the chassis and remove and disconnect the battery bank cradle from the chassis from a second side of the chassis. In various instances the chassis mounting bracket comprises an isolation mount that is structured and operable to absorb movement of the battery bank cradle relative to the chassis such that movement of the battery bank cradle relative to the chassis will not damage the battery bank cradle. Additionally, in various instances the battery bank cradle, having the battery bank disposed therein, is connected to the chassis such that a center-of-gravity of the mower is approximately equidistance from a front wheel axis and a rear wheel axis of the mower.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The drawings described herein are for illustration purposes only and are not intended to limit the scope of the present teachings in any way.

FIG. 1 is a rear isometric view of an all-electric turf vehicle, in accordance with various embodiments of the present disclosure.

FIG. 2 is a rear isometric view of the all-electric turf vehicle shown in FIG. 1 having a hood of the vehicle removed, in accordance with various embodiments of the present disclosure.

FIG. 3 is a top view of the all-electric turf vehicle shown in FIGS. 1 and 2 having a hood of the vehicle removed, in accordance with various embodiments of the present disclosure.

FIG. 4 is side view of the all-electric turf vehicle shown in FIGS. 1, 2 and 3, in accordance with various embodiments of the present disclosure.

FIG. 5 is a top view of a portion of the all-electric turf vehicle shown in FIGS. 1, 2, 3 and 4 exemplarily illustrating a battery bank and a battery bank cradle, in accordance with various embodiments of the present disclosure.

FIG. 6 is a cross-sectional view of the battery bank and the battery bank cradle, in accordance with various embodiments of the present disclosure.

FIG. 7 is an isometric view of the battery bank cradle, in accordance with various embodiments of the present disclosure.

FIG. 8 is an isometric view of the battery bank disposed within the battery bank cradle, in accordance with various embodiments of the present disclosure.

FIG. 9 is an isometric view of a front portion of the all-electric turf vehicle shown in FIGS. 1, 2, 3, 4, 5 and 6, in accordance with various embodiments of the present disclosure.

FIG. 10 is a cross-sectional view of a portion of the battery bank disposed within the battery bank cradle and mounted to a chassis of the vehicle utilizing a chassis mounting bracket, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as and non-limiting.

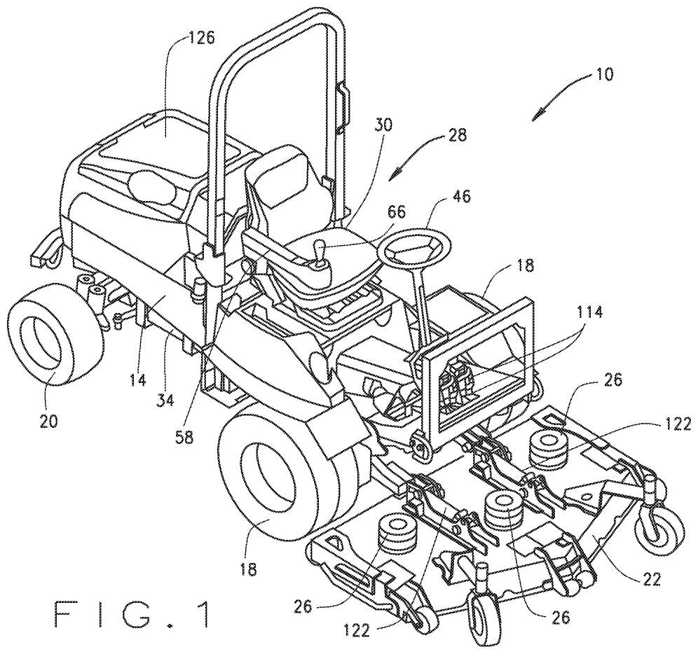

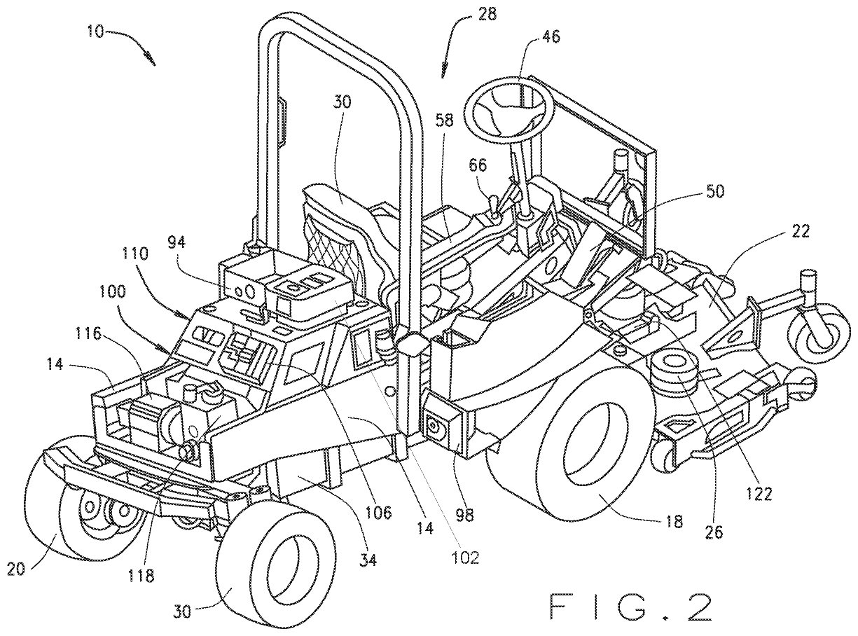

Referring now to FIGS. 1 and 2, the present disclosure provides an all-electric turf vehicle 10 (e.g., out-front rotary mower) that comprises a plurality of electrical components and controllers that control the operation and functionality of the electrical components. Importantly, the controllers are disposed and located on the vehicle 10 is close proximity to the respective components they control such that the electrical wiring harnessing connecting the controllers to the components have minimal lengths that minimize any voltage drop between the controllers and the respective components. It should be readily understood that the teachings of the present disclosure are not limited to the specific type of turf vehicles exemplarily described and illustrated herein and can be extended to a variety of applications in the turf care industry and elsewhere.

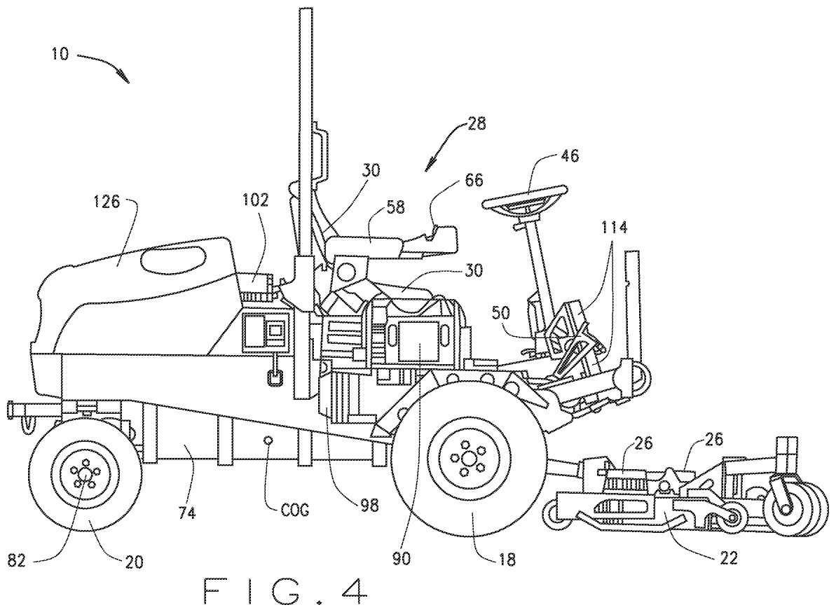

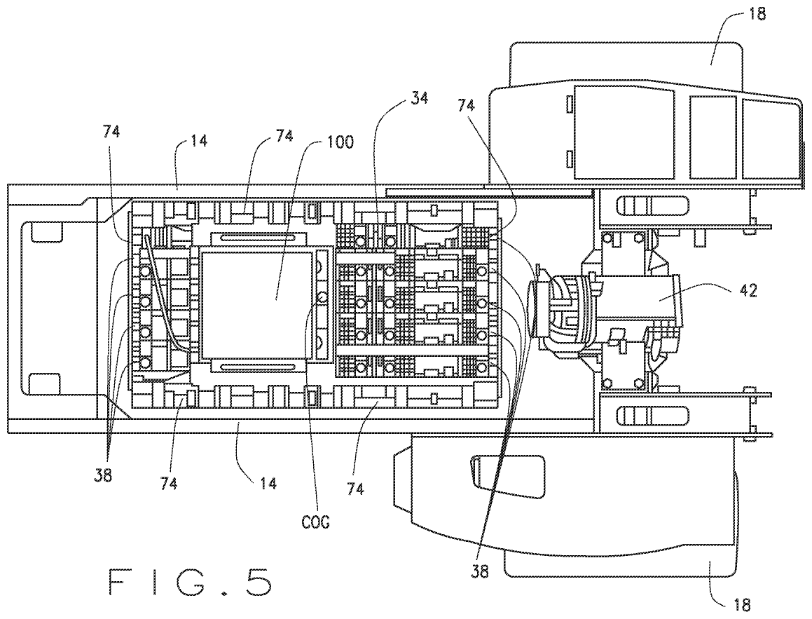

The vehicle 10 generally comprises a chassis or frame 14, one or more front ground engaging wheel 18 operably connected to the chassis 14, a one or more rear ground engaging wheel 20, and one or more rotary type turf cutting unit 22 (i.e., grass and turf cutting units) operably connected to the chassis 14. In various embodiments, the vehicle 10 comprises a single rotary type cutting unit 22 comprising a plurality of rotary cutting blades (not shown but well understood by one skilled in the art) (e.g., three rotary cutting blades), wherein each rotary cutting blade is independently driven by a separate and independent electric rotary cutting blade motor 26. In various embodiments, the cutting unit(s) 22 is/are disposed forward of the front wheels 18 and the rear wheels 20 such that the cutting unit(s) 22 precede the front and rear wheels 18 and 20 when the vehicle 10 is traversing a ground surface such that the turf or grass, or other vegetation is mowed prior to being traversed by the front and rear wheels 18 and 20, thereby ensuring a precise and consistent length of cut. The vehicle 10 also comprises an operator station 28 including a seat 30 from which an operator controls the function of the vehicle 10. The vehicle 10 additionally includes an onboard battery bank onboard battery bank 34 that is disposed generally centered between the front and rear wheels 18 and 20. The battery bank 34 comprises a plurality of battery modules 36 that each comprise a plurality of batteries 38 (best shown in FIGS. 4 and 5), wherein the battery bank 34 is electrically connected to and supplies electrical energy or power (e.g., voltage and current) to an electric traction motor 42 (e.g., and electric motor)(best shown in FIG. 5) and generally all electrically operated motors, components, controllers and other devices of the vehicle 10, as described below. The electric traction motor 42 is structured and operable to provide motive force (e.g., torque) at least one front wheel 18 to propel the vehicle 10 across the ground surface. In various embodiments, the electric traction motor 42 can deliver torque to a transaxle (not shown) that is structured and operable to transfer the torque to two front wheels 18 such that the vehicle 10 is two-wheel drive vehicle.

Generally, all operator controlled operations and functionality of the vehicle 10 (e.g., operations and functionality controlled by an operator of the vehicle 10 during operation of the vehicle 10) can be controlled from the operator station 30, via a steering wheel 46, and an accelerator/brake pedal 50, and various system controls disposed on and in a control and support arm 58 mounted adjacent the seat 30. In various embodiments, the control and support arm 58 comprises various system controls such as a joystick 66 structured and operable for controlling the operation of such things as the lifting and lowering of the cutting unit(s) 22, and a plurality of control buttons and switches 70, structured and operable for controlling the operation of such things as turning the rotary cutting blade motors 26 on and off, engaging and disengaging a park brake, turning on and off the low/high beam of the headlights, turning on and off a vehicle beacon, etc.

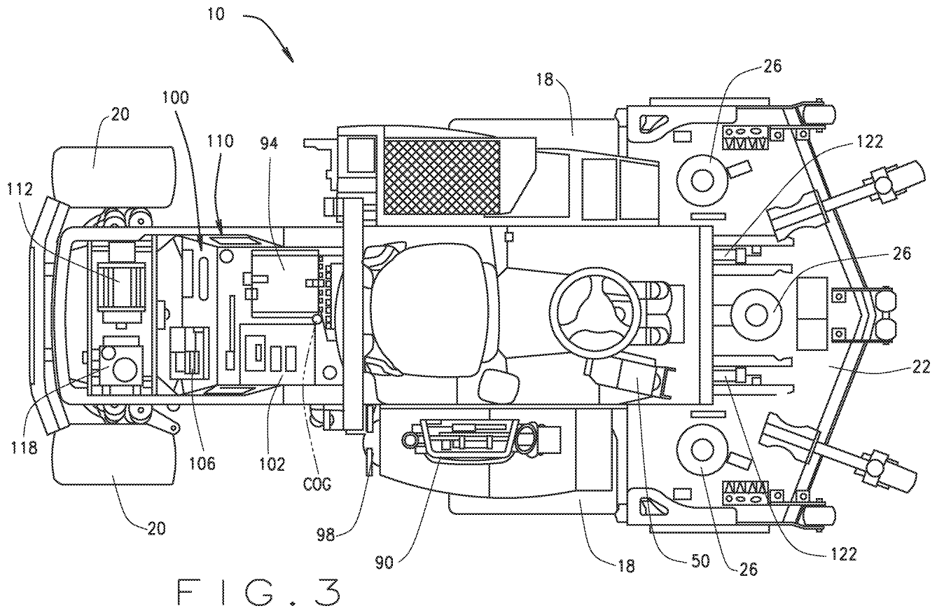

Referring now to FIGS. 1, 2, 3, 4 and 5, as described above, the vehicle 10 includes the battery bank 34 that comprises a plurality of battery modules 36 that each comprise a plurality of batteries 38, wherein the battery bank 34 is electrically connected to and supplies electrical energy or power (e.g., voltage and current) to generally all electrically operated motors, components, controllers and other devices of the vehicle 10, as described below. In various embodiments, the battery bank 34 (i.e., the plurality of battery modules 36) is disposed and housed within a battery bank cradle 74 that is removably mountable to the chassis 14. In various embodiments, the battery bank cradle comprises a main casing 74A in which the battery bank 34 (i.e., the plurality of battery modules 36) is disposable and a cover 74B this is disposable over the battery bank 34 and connectable to the main casing 74A such that the battery bank 34 can be enclosed therein and protected from debris and the environment.

In various embodiments, the battery bank cradle 74, the chassis 14, and various other structures of the vehicle 10 are structured and operable such that the battery bank cradle 74 (with or without having the battery modules 36 disposed therein) can be installed, fitted and mounted to the chassis 14 from above the chassis 14 (i.e., from the top of the vehicle 14) and then subsequently removed from below the chassis 14 (i.e., from the bottom of the vehicle 14). Hence, the battery bank cradle 74 can be installed and connected to the chassis 14 from a first side of the chassis 14 (e.g., above the chassis 14), and removed and disconnected from the chassis 14 from an opposing second side of the chassis 14 (e.g., beneath or below the chassis 14). As described below, once the battery bank cradle 74 and the battery modules 38 are installed, fitted and mounted to the chassis 14 from above the chassis 14, various components, controllers, modules, housings and other devices of the vehicle 10 are installed on top of the battery bank 34. Hence, if the batteries 38, battery modules 36 or battery bank 34 needs to be removed, replaced or repaired it would be very difficult and cumbersome to do so from above the vehicle 10. That is, in order to remove, replace or repair the battery bank 34 and battery bank cradle 74 from above the vehicle 10 it would require the time consuming and difficult task of removing all the various components, controllers, modules, housing and other devices of the vehicle 10 are installed on top of the battery bank 34. However, by structuring the battery cradle 74, the chassis 14, and various other structures of the vehicle 10 to provide removal from below the vehicle 10, where there is no obstructing components, controllers, modules, housings and other devices of the vehicle 10 that need to be removed, the battery bank cradle 74 and battery bank 34 housed therein can be easily disconnected from the chassis 14 lowered out the bottom the vehicle 10. Subsequently, after any needed removal, replacement or repair of the battery bank 34, the battery modules 36 and/or the batteries 38 has been completed the battery bank cradle 74 and battery bank 34 housed therein can be reinstalled from under the vehicle 10.

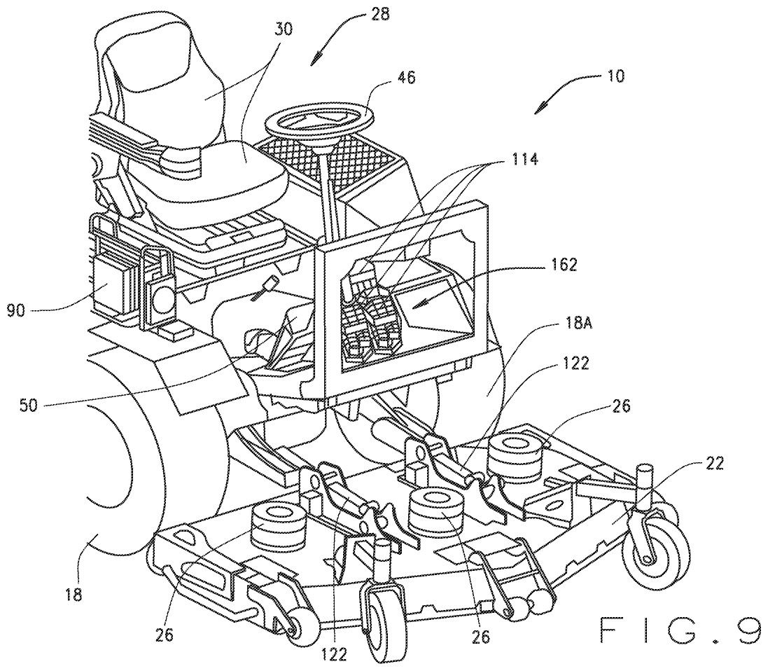

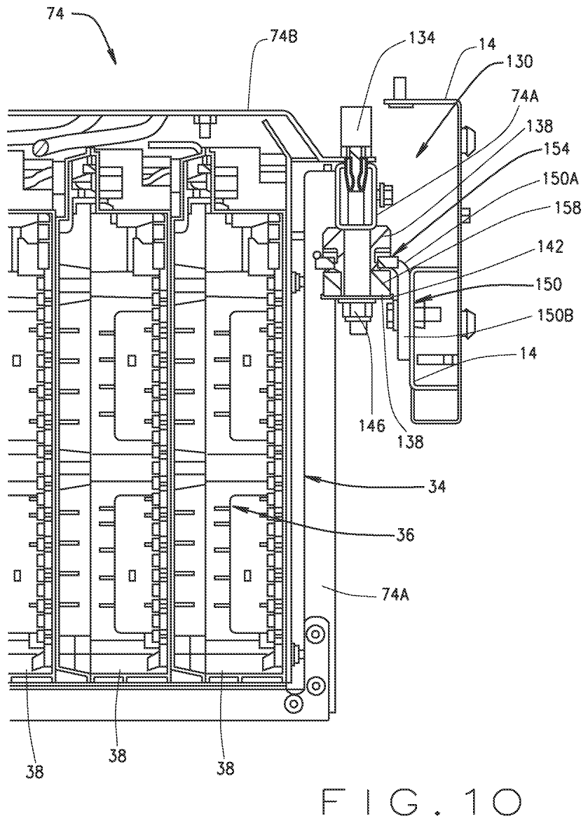

Referring now to FIG. 9, in various embodiments, the cradle 74 is mounted to the chassis 14 as described above utilizing a plurality of chassis mounting brackets 130. Each chassis mounting bracket 130 comprises a fixing bolt 134, an isolation mount 138, a rebound washer 142, a fixing nut 146 and a chassis fixing bracket 150. The chassis fixing bracket 150 is an L-shaped bracket having an arm 150A and a leg 150B. The chassis fixing bracket leg 150B is connected to the chassis 14 utilizing any suitable fixation device or method (e.g., a nut and bolt). The isolation mount 138 is disposed with an aperture 154 formed in the chassis fixing bracket arm 150A. To mount the battery bank cradle 74 to the chassis 14 from above the chassis 14, the batter bank cradle 74 (with or without the battery bank disposed therein) is lowered between opposing side channels of the chassis 14. Thereafter, the fixing bolt 134 is inserted through a lumen 158 of the isolation mount 138 and thereby through the chassis mounting bracket aperture 154. Subsequently, the rebound washer 142 is placed over the distal and of the fixing bolt 134 and the fixing nut 143 is threaded onto the distal end of the fixing bold 134 to thereby secure the battery bank cradle 74 to the chassis 14. The isolation mounts 138 of each chassis mounting bracket 130 are fabricated of a durable, flexible but resilient material (e.g., rubber) that will absorb shock, vibration and movement of the battery bank cradle 74 relative to the chassis 14 and movement of the chassis 14 relative to the battery bank cradle 74, thereby allowing the battery bank cradle 74 to move within the confines of chassis 14 and/or allowing the chassis 14 to flex relative to the battery bank cradle without damaging the battery bank cradle 74.

In various embodiments, the chassis mounting bracket 130 complete with isolation mount 138 is installed into the chassis 14 prior to installation of battery bank cradle 74, battery bank cradle 74 can then be lifted into chassis/chassis 14 from above without the battery bank cradle 74 falling through chassis/chassis 14. The battery bank cradle 74 is then secured to chassis 14 with fixing bolt 134 passing through battery bank cradle 74 and isolation mount 138 and secured on underside with rebound washer 142 and fixing nut 146. To remove the battery bank cradle 74, the chassis fixing bracket 150 can be disconnected from the chassis 14 from the underside of the vehicle 10 to allow the battery bank cradle 74 complete with chassis mounting bracket 130, isolation mount 138, fixing bolt 134, fixing nut 146 and rebound washer 143 to be lowered beneath the vehicle 10. The ability to lower and remove the battery bank from beneath the vehicle 10 for repairs and replacement is advantageous because, as described above, there are several components (e.g., the power distribution unit (PDU) and fuse box 94, the battery management system (BMS) 100, the battery charger controller 102, an electro-hydraulic powerpack (EHP) controller 106, a DC/DC voltage converter 110, etc.) disposed above the battery bank 34 and battery bank cradle 74 that would need to be removed prior to removal of the battery bank cradle 74 and battery bank 34. However, it should be noted that the battery bank cradle 74 and battery bank 34 can be removed for replacement and repair from above the vehicle 10 if desired.

Additionally, in various embodiments, the battery bank cradle 74 and battery bank 34 housed therein is mounted centrally within the vehicle 10. More specifically, the battery bank cradle 74 and battery bank 34 housed therein is mounted to the chassis 14 such that a longitudinal center of battery bank cradle 74 and battery bank 34 housed therein is generally longitudinally centered between a front wheel axis 78 extending laterally through a center of the one or more front wheel 18 and a rear wheel axis 82 extending laterally through a center of the one or more rear wheel 20. That is, the longitudinal center of the battery bank cradle 74 and battery bank 34 is located approximately equidistance from the front wheel axis 78 and the rear wheel axis 82. Furthermore, in various embodiments the battery bank cradle 74 and battery bank 34 housed therein is mounted to the chassis 14 such that a bottommost surface of the battery bank cradle 74 is located a desired distance L from a ground surface in order to provide a low center-of-gravity (COG) of the vehicle 10. Particularly, the battery bank cradle 74 and battery bank 34 housed therein is mounted to the chassis 14 such that the COG of the vehicle 10 is located approximately at the longitudinal center of the vehicle 10. That is, the COG is located approximately equidistance from the front wheel axis 78 and the rear wheel axis 82. This provides the vehicle 10 with a low and centered weight distribution relative to the front and rear wheels 18 and 20. The low and centered weight distribution minimizes pitch of the vehicle when traversing undulating or rough terrain, and provides the vehicle 10 with stability and good handling across generally contours and types of terrains. The low COG also maximizes slope climbing performance of the vehicle 10. For example, in various embodiments, the battery bank cradle 74 and battery bank 34 housed therein is mounted to the chassis 14 such that the bottommost surface of the battery bank cradle 74 (i.e., the lowest part of the battery bank cradle 74 when mounted to the chassis 14) is the distance L above the ground surface (when the vehicle is sitting on a substantially level ground surface). In various embodiments, the distance L can be between approximately 150 mm to 350 mm, for example between approximately 250 mm and 300 mm, in various instances approximately 189 mm. Additionally, in various embodiments, the battery bank cradle is constructed of a durable material that will protect the battery modules 36 and batteries 38 from damage by debris that may be thrown up from under the vehicle 10 during operation of the vehicle 10. For example, in various embodiments, the battery bank cradle can be fabricated of a metal (e.g., steel), a carbon fiber material, a durable plastic material, etc.

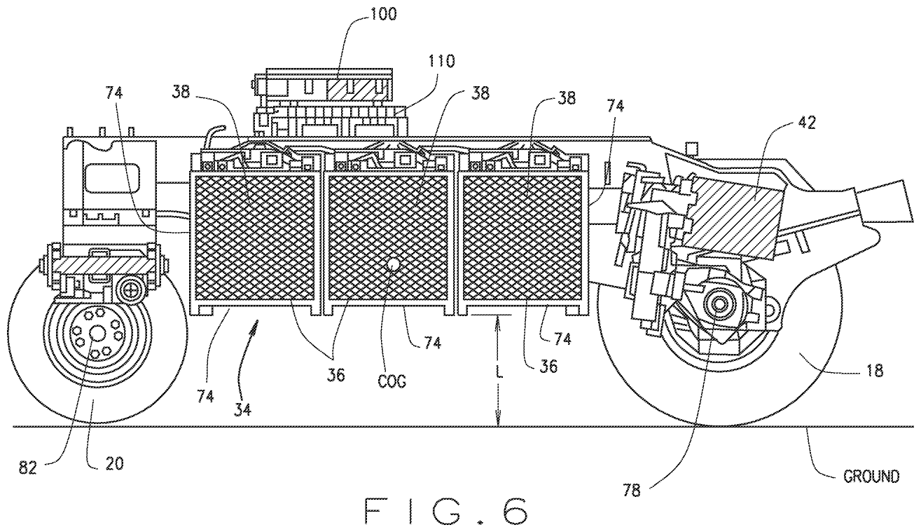

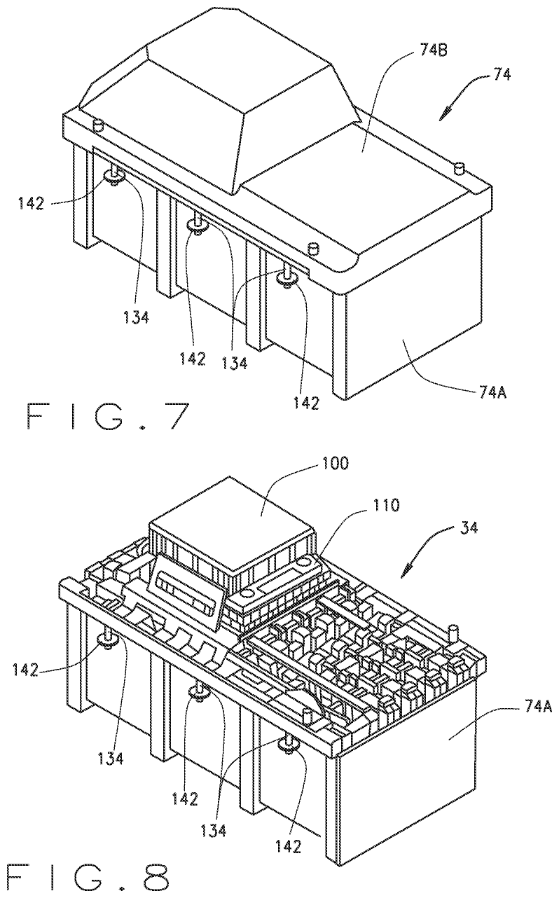

Referring now to FIGS. 2, 3, 4, 5, 6 and 9, in various embodiments, the vehicle 10 comprises a master control unit (MCU) 90 that is structured and operable to controls communications to and from, to thereby control the operation of, the traction motor 42 and generally other electronic controllers, electrical powered components and systems of the vehicle 10 such as a power distribution unit (PDU) and fuse box 94, a traction control unit (TCU) 98, a battery management system (BMS) 100, a battery charger controller 102, an electro-hydraulic powerpack (EHP) controller 106, a DC/DC voltage converter 110, the electric rotary cutting unit motor controllers 114, etc.

The PDU and fuse box 94 is structured and operable to receive electrical power (i.e., voltage and current) from the battery bank 34 and distribute the power to the traction motor 42 and various controllers, motors and components of the vehicle 10. In various embodiments, the PDU and fuse box 94 can be located on top of the battery bank 34 and under the hood 126 (when the hood 126 is in a Closed position) such that the battery bank 34 protects the PDU and fuse box 94 from possible damage caused by flying debris they may fly up from under the vehicle 10 during operation and the hood 126 protects the PDU and fuse box 94 from environmental elements from above the vehicle 10 such as rain, sun, snow, dust and other environmental elements. Additionally, the PDU and fuse box 94 is located such that it is easily accessible by raising a hood 126. Furthermore, the PDU and fuse box 94 is disposed under the hood 126 (when the hood 126 is in a Closed position) and centrally located the within the vehicle 10 relative to the front and rear of the vehicle 10 (e.g., approximately equal distance from the forwardmost edge of the cutting unit 22 as from the rearmost edged of the chassis 14) such that the length of wire harnessing connecting the PDU and fuse box 94 to the traction motor 42 and various controllers, motors and components fore and aft have the shortest possible length thereby minimizing a voltage drop between the PDU and fuse box 94 and the traction motor 42 and the respective various controllers, motors and components. For example, in various embodiments, the PDU and fuse box 94 is located within approximately 775 mm to 875 mm, e.g., 825 mm, of the traction motor 42 such that the wire harnessing therebetween is approximately 1400 mm to 1500 mm, e.g., 1450 mm, thereby significantly reducing the voltage drop between the PDU and fuse box 94 and the traction motor 42 compared to the voltage drop between PDUs and traction motors of known turf vehicles. Furthermore, locating the PDU and fuse box 94 on top of the battery bank 34 and centrally relative to the front and rear of the vehicle 10 provides easy access to the PDU and fuse box 94 to replace fuses and repair, monitor, read, program, replace, etc. the PDU and fuse box 94.

The EHP controller 106 generally controls the operation of a hydraulic fluid powerpack 116 that is structured and operable to provide a flow of hydraulic fluid from a hydraulic fluid tank 118 to and from a plurality of hydraulic cutting unit actuators 122 that are structured and operable to raise and lower the cutting unit(s) 22. In various embodiments, the EHP controller 106 is located on top of the battery bank 34 and under the hood 126 (when the hood 126 is in a Closed position) such that the battery bank 34 protects the EHP controller 106 from possible damage caused by flying debris they may fly up from under the vehicle 10 during operation and the hood 126 protects the EHP controller 106 from environmental elements from above the vehicle 10 such as rain, sun, snow, dust and other environmental elements. Additionally, the EHP controller 106 is located such that it is easily accessible by raising a hood 126. Furthermore, the EHP controller 106 is located in close proximity to the PDU and fuse box 94 such that the length of wire harnessing connecting the EHP controller 106 to the PDU and fuse box 94 has the shortest possible length, thereby minimizing a voltage drop between the EHP controller 106 and the PDU and fuse box 94. For example, in various embodiments, the EHP controller 106 is located within approximately 300 mm and 400 mm, e.g., 350, of the PDU and fuse box 94 such that the wire harnessing therebetween is approximately 400 mm to 500 mm, e.g., 450 mm, thereby significantly reducing the voltage drop between the EHP controller 106 and the PDU and fuse box 94 compared to the voltage drop between PDUs and EPH controllers of known turf vehicles.

The DC/DC converter 110 is structured and operable to regulate the power (e.g., voltage and current) that is delivered to the traction motor 42 and various controllers, motors and components of the vehicle 10 from the battery bank 34. For example, in various embodiments, the DC/DC converter 110 receives 48 volts from the battery bank 34, steps the 48 volts down to 12 volts, and delivers 12 volts to all 12 volt components, controllers and devices of the vehicle 10. In various embodiments DC/DC converter 110 is disposed on top of the battery bank 34 and under the hood 126 (when the hood 126 is in a Closed position) such that the battery bank 34 protects the DC/DC converter 110 from possible damage caused by flying debris they may fly up from under the vehicle 10 during operation and the hood 126 protects the DC/DC converter 110 from environmental elements from above the vehicle 10 such as rain, sun, snow, dust and other environmental elements. Additionally, DC/DC converter 110 is located such that it is easily accessible by raising a hood 126. Furthermore, the DC/DC converter 110 is located in close proximity to the PDU 94 such that the length of wire harnessing connecting the DC/DC converter 110 to the PDU and fuse box 94 has the shortest possible length, thereby minimizing a voltage drop between the DC/DC converter 110 and the PDU and fuse box 94. For example, in various embodiments, the DC/DC converter 110 is located within approximately 875 mm and 975 mm, e.g., 925, of the PDU and fuse box 94 such that the wire harnessing therebetween is approximately 1865 mm to 1965 mm, e.g., 1915 mm, thereby significantly reducing the voltage drop between the DC/DC converter 110 and the PDU and fuse box 94 compared to the voltage drop between DC/DC converters and PDUs of known turf vehicles.

The BMS 100 is structured and operable to monitor various battery data such as the state of charge of the battery bank 34 and/or the battery modules 36 and/or the individual batteries 38, the operational status of the battery bank 34 and/or the battery modules 36 and/or the individual batteries 38, and the functional status of the individual batteries 38 (e.g., do any individual batteries 38 have a fault cell), etc. In various embodiments, the BMS 100 is mounted on top of the battery bank 34 and under the hood 126 (when the hood 126 is in a Closed position) such that the battery bank 34 protects the BMS 100 from possible damage caused by flying debris they may fly up from under the vehicle 10 during operation and the hood 126 protects the BMS 100 from environmental elements from above the vehicle 10 such as rain, sun, snow, dust and other environmental elements. Additionally, the BMS is located such that it is easily accessible by raising a hood 126. Furthermore, the BMS 100 is located in close proximity to the battery bank 34 such that the length of wire harnessing connecting the BMS 100 to the battery bank 34 and/or the battery modules 36 and/or the individual batteries 38 have the shortest possible length, thereby minimizing a voltage drop between the BMS 100 and the battery bank 34 and/or the battery modules 36 and/or the individual batteries 38. For example, in various embodiments, the BMS 100 is located within approximately 150 mm and 250 mm, e.g., 200, of the battery bank 34 and/or the battery modules 36 and/or the individual batteries 38 such that the wire harnessing therebetween is approximately 300-1175 mm, thereby significantly reducing the voltage drop between the BMS 100 and the battery bank 34 and/or the battery modules 36 and/or the individual batteries 38 compared to the voltage drop between BMSs and battery bank 34 and/or battery modules 36 and/or individual batteries 38 of known turf vehicles.

The TCU 98 is structured and operable to control the torque and rotational speed delivered by the electric traction motor 42 to one or more of the of front wheel(s) 18 (in various instances via a transaxle) such that the torque and rotational speed of the front wheel(s) 18 is controlled based on operator speed controls (e.g., accelerator/brake pedal 50 positioning), the terrain over which the vehicle 10 is traveling and/or the direction of turn the vehicle 10 is traveling. In various embodiments, the TCU 98 is mounted on an exterior outboard side of the vehicle 10 in close proximity to the PDU 94 such that the length of wire harnessing connecting the TCU 98 to the PDU 94 has the shortest possible length, thereby minimizing a voltage drop between the TCU 98 and PDU 94. For example, in various embodiments, the TCU 98 is located within approximately 625 mm and 725 mm, e.g., 675, of the PDU 94 such that the wire harnessing therebetween is approximately 1350 mm to 1450 mm, e.g., 1400 mm, thereby significantly reducing the voltage drop between the TCU 98 and the PDU 94 compared to the voltage drop between TCUs and PDUs of known turf vehicles. Additionally, in various embodiments, the TCU 98 is mounted on an exterior outboard side of the vehicle 10 in close proximity to the electric traction motor 42 such that the length of wire harnessing connecting the TCU 98 to the traction motor 42 has the shortest possible length, thereby minimizing a voltage drop between the TCU 98 and traction motor. For example, in various embodiments, the TCU 98 is located within approximately 580 mm and 680 mm, e.g., 630, of the traction motor 42 such that the wire harnessing therebetween is approximately 830 mm to 930 mm, e.g., 880 mm, thereby significantly reducing the voltage drop between the TCU 98 and the traction motor 42 compared to the voltage drop between TCUs and PDUs of known turf vehicles.

In various embodiments, the battery charger controller 102 is mounted on top of the battery bank 34 and under the hood 126 (when the hood 126 is in a Closed position) such that the battery bank 34 protects the battery charger controller 102 from possible damage caused by flying debris they may fly up from under the vehicle 10 during operation and the hood 126 protects battery charger controller 102 from environmental elements from above the vehicle 10 such as rain, sun, snow, dust and other environmental elements. Additionally, the battery charger controller 102 is located such that it is easily accessible by raising a hood 126. The battery changer controller 102 is structured and operable to control, regulate and modulate power from a shore power source (e.g., a power source not disposed on the vehicle 10) to the batteries 38 of battery bank 34 so that the batteries 38 do not overcharge. The battery charger controller 102 is mounted on top of the battery bank 34. Generally, the individual batteries 38 electrically connect to the BMS 100 electrically connects to the individual batteries 38, which in turn connects to a positive and negative buss bar (not shown), which connects to the battery bank 34. Additionally, in various embodiments, the battery charger controller 102 is mounted in close proximity to the BMS 100 such that the length of wire harnessing connecting the battery charger controller to the BMS 100 has the shortest possible length, thereby minimizing a voltage drop between the TCU 98 and traction motor. For example, in various embodiments the battery charger controller 102 is mounted within approximately 250 mm and 350 mm, e.g., 300, of the BMS 100 such that the wire harnessing therebetween is approximately 1075 mm to 1175 mm, e.g., 1125 mm, thereby significantly reducing the voltage drop between the battery charger controller 102 and the BMS 100 compared to the voltage drop between battery charger controllers and BMSs of known turf vehicles.

Each of the rotary cutting unit motor controllers 114 is structured and operable to independently control the operation of a respective one of the rotary cutting blade motors 26 to thereby independently control the operational status (e.g., On or Off) and the rotational speed of each rotary cutting blade. In various embodiments, the rotary cutting unit motor controllers 114 are mounted to structure of the vehicle 10 at the front of the operator station 28 in front of the steering wheel 46 and forward of the front wheel axis 78 in close proximity to the rotary cutting blade motors 26 such that the length of wire harnessing connecting each rotary cutting unit motor controllers 114 to the respective rotary cutting blade motor 26 has the shortest possible length, thereby minimizing a voltage drop between each rotary cutting unit motor controllers 114 to the respective rotary cutting blade motor 26. For example, in various embodiments each rotary cutting unit motor controller 114 is mounted within approximately 600 mm to 850 mm of the respective rotary cutting blade motor 26 when the respective cutting unit 22 is in a fully lowered position, such that the wire harnessing therebetween is approximately 2150 mm to 2200 mm, thereby significantly reducing the voltage drop between the each rotary cutting unit motor controller 114 and the respective rotary cutting blade motor 26 compared to the voltage drop between cutting unit motor controllers and cutting blade motors of known turf vehicles. Additionally, by mounting the rotary cutting unit motor controllers 114 to structure of the vehicle 10 at the front of the operator station 28 in front of the steering wheel 46 and forward of the front wheel axis 78 in close proximity to the rotary cutting blade motors 26, the rotary cutting unit motor controllers 114 are exposed to open air, and a fresh air flow when the vehicle 10 is moving forward, that aids in cooling of the rotary cutting unit motor controllers 114. In various embodiments, the rotary cutting unit motor controllers 114 can be mounted within a hinged housing 162 to provide protection for dirt, debris and environmental element, wherein the housing is structured and operable to provide quick access to the rotary cutting unit motor controllers 114.

As described above, various controllers, modules, components and devices of the vehicle 10 (e.g., the PDU and fuse box 94, the BMS 100, the battery charger controller 102, the EHP controller 106 and the DC/DC converter 110) are mounted on top of the battery bank 34 and under the hood 126 when hood 126 is in a Closed position. Accordingly, the battery bank 34 provides protection for such controllers, modules, components and devices of the vehicle 10 from water, mud, dust and other debris that may be thrown up under the vehicle 10 during operation, and also provides protection for such controllers, modules, components and devices of the vehicle 10 from environmental elements from above the vehicle 10 such as rain, sun, snow, dust and other environmental elements. This reduces build up of dirt, dust, sludge and other debris on controllers, modules, components and devices of the vehicle 10, thereby reduce the amount of wear and thermal build upon on the various wire harnessing described herein. Additionally, locating such controllers, modules, components and devices of the vehicle 10 on top of the battery bank 34 and under the hood 126 provides easy access to such controllers, modules, components and devices of the vehicle 10 such that resettable fuses can be easily accessed with no tools and the various controllers modules, components and devices can be replaced with minimal work. Accordingly, the layout and positioning of the controllers, modules, components and devices and described above provides improved access to all serviceable controllers, modules, components and devices on a vehicle 10 and locates them in an area which has a reduced build up in debris.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. An all-electric turf vehicle, said vehicle comprising:
a chassis;
a plurality of ground engaging wheels operatively connected to the chassis;
an operator station;
a turf cutting unit operatively connected to the chassis, wherein the turf cutting unit comprises a plurality of rotary cutting blades driven by a plurality of electric rotary cutting blade motors;
a battery bank structured and operable to provide electrical power to the plurality of electric rotary cutting blade motors; and
a battery bank cradle that is removably connected to the chassis, wherein the battery bank cradle houses the battery bank and is structured to be installed and connected to the chassis from a first side of the chassis and removed and disconnected from the chassis from a second side of the chassis.

2. The vehicle of claim 1, wherein a longitudinal center of the battery bank cradle is located approximately equidistance from a front wheel axis and a rear wheel axis of the vehicle.

3. The vehicle of claim 2, wherein the battery bank cradle is connected to the chassis such that a bottommost portion of the battery bank cradle is between 250 mm and 300 mm from a ground surface on which the vehicle is disposed.

4. The vehicle of claim 3 wherein the battery bank cradle is connected to the chassis such that with the battery bank disposed therein a center-of-gravity of the vehicle is approximately equidistance from the front wheel axis and the rear wheel axis of the vehicle.

5. The vehicle of claim 4, wherein the battery bank cradle is removably connected to the chassis utilizing a chassis mounting bracket that includes an isolation mount.

6. The vehicle of claim 4 further comprising a power distribution unit and fuse box structured and operable to receive electrical power from the battery bank and distribute the power to a traction motor of the vehicle, wherein the power distribution unit and fuse box is disposed on top of the battery bank and under a hood of the vehicle such that the battery bank protects the power distribution unit and fuse box from debris from under the vehicle and the hood protects the power distribution unit and fuse box from environmental elements from above the vehicle.

7. The vehicle of claim 6 further comprising an electro-hydraulic powerpack controller structured and operable to provide a flow of hydraulic fluid from a hydraulic fluid tank of the vehicle to and from at least one hydraulic cutting unit actuator of the vehicle that is structured and operable to raise and lower the turf cutting unit, wherein the electro-hydraulic powerpack controller is disposed on top of the battery bank and under a hood of the vehicle such that the battery bank protects the electro-hydraulic powerpack controller from debris from under the vehicle and the hood protects the electro-hydraulic powerpack controller from environmental elements from above the vehicle.

8. The vehicle of claim 4 further comprising a DC/DC converter structured and operable to regulate electrical power delivered to a traction motor of the vehicle from the battery bank, wherein the DC/DC converter is disposed on top of the battery bank and under a hood of the vehicle such that the battery bank protects the DC/DC converter from debris from under the vehicle and the hood protects the DC/DC converter from environmental elements from above the vehicle.

9. The vehicle of claim 4 further comprising a battery management system structured and operable to monitor a state of charge of the battery bank, wherein the battery management system is disposed on top of the battery bank and under a hood of the vehicle such that the battery bank protects the battery management system from debris from under the vehicle and the hood protects the battery management system from environmental elements from above the vehicle.

10. The vehicle of claim 9 further comprising a battery changer controller structured and operable to regulate power from a shore power source to the battery bank, wherein the battery changer controller is disposed on top of the battery bank and under a hood of the vehicle such that the battery bank protects the battery changer controller from debris from under the vehicle and the hood protects the battery changer controller from environmental elements from above the vehicle.

11. The vehicle of claim 4 further comprising a plurality of rotary cutting unit motor controllers structured and operable to independently control the operation of a respective one of the plurality rotary cutting blade motors to thereby independently control the operational status and the rotational speed of each rotary cutting blade, wherein the plurality of the rotary cutting unit motor controllers are mounted to the vehicle at a front of the operator station such that the rotary cutting unit motor controllers are exposed to an air flow when the vehicle is moving forward.

12. An all-electric turf mower, said mower comprising:
a chassis;
a plurality of ground engaging wheels operatively connected to the chassis;
an operator station;
a turf cutting unit operatively connected to the chassis, wherein the turf cutting unit comprises a plurality of rotary cutting blades driven by a plurality of electric rotary cutting blade motors;
a battery bank structured and operable to provide electrical power to the plurality of electric rotary cutting blade motors; and
a battery bank cradle having the battery bank disposed therein, the battery bank cradle removably connected to the chassis utilizing a chassis mounting bracket structured and operable to install and connect the battery bank cradle to the chassis from a first side of the chassis and remove and disconnect the battery bank cradle from the chassis from a second side of the chassis,
wherein the chassis mounting bracket comprises an isolation mount that is structured and operable to absorb movement of the battery bank cradle relative to the chassis such that movement of the battery bank cradle relative to the chassis will not damage the battery bank cradle, and
wherein the battery bank cradle having the battery bank disposed therein is connected to the chassis such that a center-of-gravity of the mower is approximately equidistance from a front wheel axis and a rear wheel axis of the mower.

13. The mower of claim 12, wherein a longitudinal center of the battery bank cradle is located approximately equidistance from a front wheel axis and a rear wheel axis of the mower.

14. The mower of claim 13, wherein the battery bank cradle is connected to the chassis such that a bottommost portion of the battery bank cradle is between 250 mm and 300 mm from a ground surface on which the mower is disposed.

15. The mower of claim 14 further comprising a power distribution unit and fuse box structured and operable to receive electrical power from the battery bank and distribute the power to a traction motor of the mower, wherein the power distribution unit and fuse box is disposed on top of the battery bank and under a hood of the mower such that the battery bank protects the power distribution unit and fuse box from debris from under the mower and the hood protects the power distribution unit and fuse box from environmental elements from above the mower.

16. The mower of claim 15 further comprising an electro-hydraulic powerpack controller structured and operable to provide a flow of hydraulic fluid from a hydraulic fluid tank of the mower to and from at least one hydraulic cutting unit actuator of the mower that is structured and operable to raise and lower the turf cutting unit, wherein the electro-hydraulic powerpack controller is disposed on top of the battery bank and under a hood of the mower such that the battery bank protects the electro-hydraulic powerpack controller from debris from under the mower and the hood protects the electro-hydraulic powerpack controller from environmental elements from above the mower.

17. The mower of claim 14 further comprising a DC/DC converter structured and operable to regulate electrical power delivered to a traction motor of the mower from the battery bank, wherein the DC/DC converter is disposed on top of the battery bank and under a hood of the mower such that the battery bank protects the DC/DC converter from debris from under the mower and the hood protects the DC/DC converter from environmental elements from above the mower.

18. The mower of claim 14 further comprising a battery management system structured and operable to monitor a state of charge of the battery bank, wherein the battery management system is disposed on top of the battery bank and under a hood of the mower such that the battery bank protects the battery management system from debris from under the mower and the hood protects the battery management system from environmental elements from above the mower.

19. The mower of claim 18 further comprising a battery changer controller structured and operable to regulate power from a shore power source to the battery bank, wherein the battery changer controller is disposed on top of the battery bank and under a hood of the mower such that the battery bank protects the battery changer controller from debris from under the mower and the hood protects the battery changer controller from environmental elements from above the mower.

20. The mower of claim 14 further comprising a plurality of rotary cutting unit motor controllers structured and operable to independently control the operation of a respective one of the plurality rotary cutting blade motors to thereby independently control the operational status and the rotational speed of each rotary cutting blade, wherein the plurality of the rotary cutting unit motor controllers are mounted to the mower at a front of the operator station such that the rotary cutting unit motor controllers are exposed to a fresh air flow when the mower is moving forward.
